(19) United States
(12) Patent Application Publication
(10) Pub. No.: US 2009/0268187 A1
(43) Pub. Date: Oct. 29, 2009

(54) EXPOSURE SYSTEM

(76) Inventors: Teng-Yen Huang, Taipei City (TW); Chia-Wei Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/178,600

(22) Filed: Jul. 23, 2008

(30) Foreign Application Priority Data
Apr. 28, 2008 (TW) 097115556

(51) Int. Cl. G03B 27/72

(52) U.S. Cl. 355/71

(57) ABSTRACT

An exposure system includes a light source for generating an exposure light, a mask, a lens system, and a bandwidth-filtering module for narrowing bandwidth of the exposure light. The mask, the lens system and the bandwidth-filtering module are sequentially disposed on a light path of the exposure light.

### BACKGROUND OF THE INVENTION

1. Field of the Invention

The present invention relates to an exposure system, and more particularly, to an exposure system having a bandwidth-filtering module added therein to improve critical dimension (CD) uniformity.

2. Description of the Prior Art

With the advancements of wafer manufacturing processing, the scale of semiconductor manufacturing is reduced. In the manufacturing process of the integrated circuit, the key to the technology is the lithography process, which is responsible for accurately transferring the pattern in a mask to the various device layers on wafer. While the scale of semiconductor is reduced, the critical dimensions (CD) of channel length, junction depth, and gate thickness of a field effect transistor (FET), for example, are reduced, as well. These CDs should be accurately controlled because a little change in the CDs may cause a lot of change in the characteristics of the semiconductor element.

Referring to FIG. 1, FIG. 1 is a schematic diagram illustrating an exposure system according to the prior art. As shown in FIG. 1, an exposure system includes a light source 12, a lens system 14, a mask stage 16, a projection lens 18 and a wafer stage 20, wherein an exposure light is generated by the light source 12, such as I-line, a KrF laser(248 nm), a ArF laser(193 nm), etc., the lens system 14, the mask stage 16, the projection lens 18 and the wafer stage 20 are respectively disposed on a light path of the exposure light sequentially. While the exposure process is performed, a substrate 22 desired to be exposed is disposed on the wafer stage 20, and a mask 24 with a pattern desired to be projected on the substrate 22 is disposed on the mask stage 16.

Before the exposure light enters the mask 24, the exposure light will pass through the lens system 14 having many optical devices. However, the lens system 14 is a non-linear optical system. For this reason, while the exposure light passes through the lens system 14, a coupling effect is generated in the exposure light so as to cause the phenomenon of dispersion. The bandwidth of spectrum of the exposure light is therefore widened. Since the exposure light passing through the mask 24 has a wider bandwidth of spectrum, the CD uniformity on substrate 22 becomes worse after the exposure light passing through the projection lens 18 is projected on the substrate 22 with the reduction of the desired CD. Therefore, it is an important task to effectively increase the CD uniformity.

### SUMMARY OF THE INVENTION

It is therefore a primary object of the present invention to provide an exposure system having a bandwidth filtering module to improve the CD uniformity.

According to the claimed invention, an exposure system for utilizing an exposure light emitted from a light source to irradiate a mask and project on a substrate is provided. The exposure system comprises a bandwidth-filtering module disposed on a light path of the exposure light and utilized to narrow a bandwidth of spectrum of the exposure light.

According to the claimed invention, an exposure system for projecting a pattern on a substrate is provided. The exposure system comprises a light source for generating an exposure light, a mask stage disposed on a light path of the exposure light and utilized to hold a mask, a condenser lens disposed the light path of the exposure light and utilized to condense the exposure light, and a bandwidth-filtering module disposed on the light path of the exposure light and utilized to narrow a bandwidth of spectrum of the exposure light, wherein the bandwidth-filtering module is disposed between the condenser lens and the mask stage on the light path of the exposure light.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an exposure system according to the prior art.

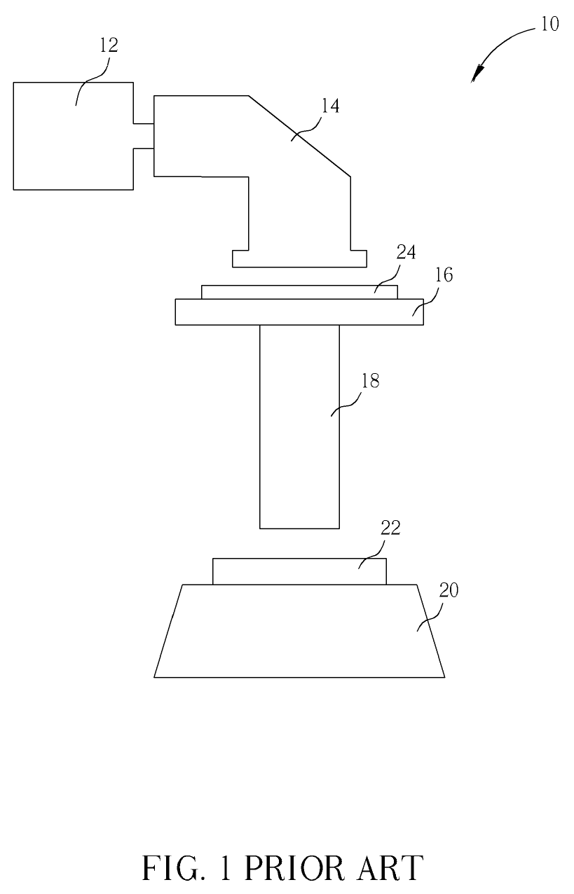

FIG. 2 is a schematic diagram illustrating an exposure system according to a preferred embodiment of the present invention.

FIG. 3 is a schematic diagram illustrating a spectrum of the exposure light.

FIG. 4 is a schematic diagram illustrating a grating.

FIG. 5 is a schematic diagram illustrating a correlation between an aperture of a contact hole and CD sensitivity on the substrate in the condition of the exposure light having different bandwidths of spectrum.

FIG. 6 is a schematic diagram illustrating an example of the exposure system according to the present invention.

### DETAILED DESCRIPTION

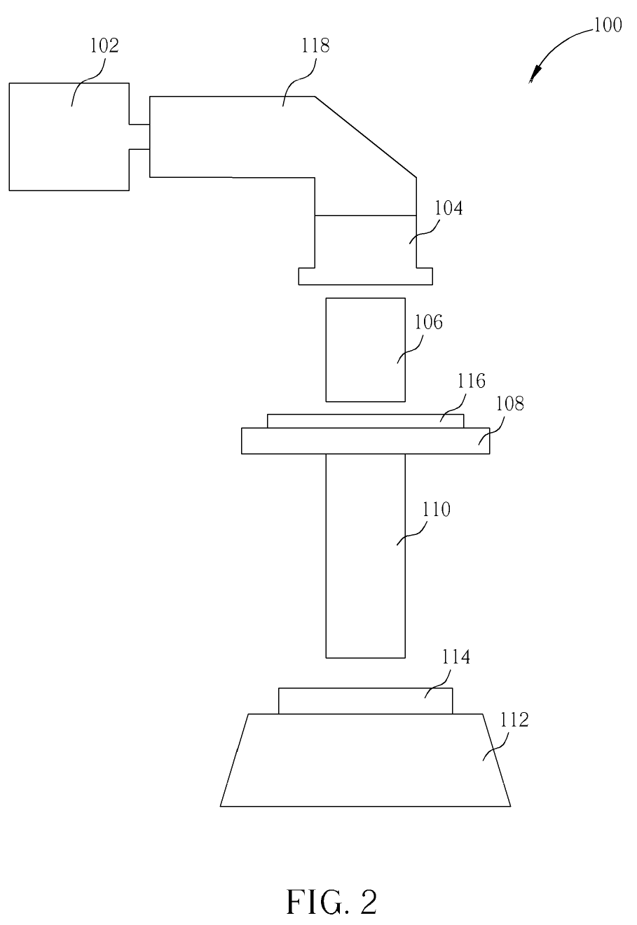

Referring to FIG. 2, FIG. 2 is a schematic diagram illustrating an exposure system according to a preferred embodiment of the present invention. As shown in FIG. 2, the exposure system 100 of the present invention includes a light source 102, a condenser lens 104, a bandwidth-filtering module 106, a mask stage 108, a projection lens 110 and a wafer stage 112, wherein the condenser lens 104, the bandwidth-filtering module 106, the mask stage 108, the projection lens 110 and the wafer stage 112 are respectively disposed on a light path of an exposure light generated by the light source 102 sequentially.

As shown in FIG. 2, while performing the exposure process, a substrate 114 desired to be exposed is disposed on the wafer stage 112, and a mask 116 with a mask pattern desired to be projected on the substrate 114 is disposed on the mask stage 108. The exposure light will be emitted from the light source 102, and then sequentially passes through the condenser lens 104, the bandwidth-filtering module 106 and the mask 116. Thereafter, the exposure light with the mask pattern enters the projection lens 110, and finally, the exposure light exits and projects on the substrate 114 so as to make a photoresist on the substrate 114 have the mask pattern in mask 116. Furthermore, the condenser lens 104 is utilized to condense the exposure light and the projection lens 110 has functions of contraction or enlargement so as to project the exposure light with a certainly proportional mask pattern on the substrate 114.

It should be noted that the bandwidth-filtering module 106 disposed between the condenser lens 104 and the mask stage 108 is utilized to reduce a bandwidth of spectrum of the exposure light. The bandwidth-filtering module 106 can be a grating module, a Fabry-Perot interferometer, a distributed feedback (DFB) filter or a distributed Bragg reflector (DBR). But the present invention is not limited to the above-mentioned bandwidth-filtering module, and the other devices having functions of filtering or splitting light also can be utilized to replace.

In addition, the position of the bandwidth-filtering module 106 is not limited to be disposed between the condenser lens 104 and the mask stage 108, and the exposure light should sequentially pass through the condenser lens 104, the bandwidth-filtering module 106 and the mask 116. The condition that no optical element is disposed between the bandwidth-filtering module 106 and the mask 116 is preferred. When the exposure light passing through the bandwidth-filtering module 106 irradiates the mask 116, the mask pattern transferred by the exposure light can have a better resolution.

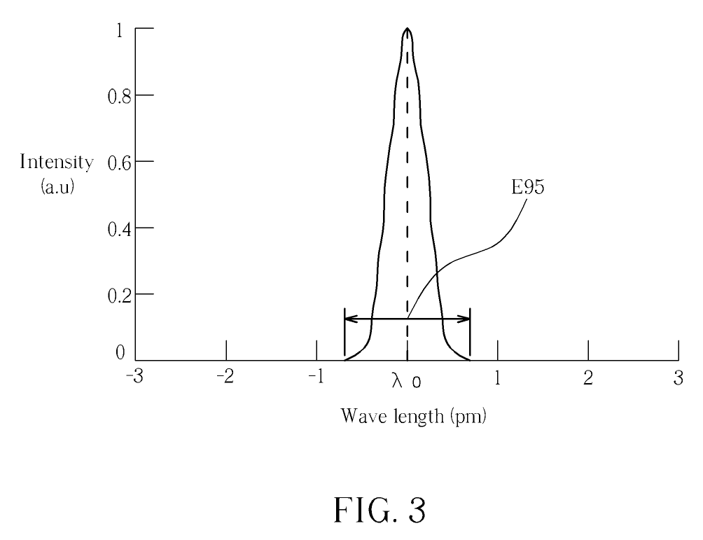

Furthermore, in order to fabricate a smaller semiconductor device, the smaller the wavelength of the exposure light projected to the substrate is, the better semiconductor device is fabricated. The light source 102 can be KrF laser, ArF laser or F2 laser. The present invention is not limited to the above-mentioned lasers, and the wavelength of the light source can be chosen according to the actual requirements. Referring to FIG. 3, FIG. 3 is a schematic diagram illustrating a spectrum of the exposure light. As shown in FIG. 3, the exposure light has continuous wavelengths of a spectrum. In the spectrum, the exposure light has a center wavelength λ₀ and the center wavelength λ₀ is located at a maximum intensity of the exposure light in the spectrum. An area under a curve of the spectrum represents energy of the exposure light. An E95 is defined as the bandwidth of spectrum which has an energy that is 95% of the energy of the exposure light; that is the bandwidth of wavelength of 95% of the integral area under the curve of the spectrum.

In addition, the exposure system 100 further includes a lens system 118 disposed between the light source 102 and the condenser lens 104 on the light path. The lens system 118 and the condenser lens 104 constitute a nonlinear optical system. Therefore, when the exposure light passes through the lens system 118 and the condenser lens 104 having a nonlinear optical characteristic, a coupling effect is generated in the exposure light, so that the exposure light has a phenomenon of dispersion after passing through the lens system 118 and the condenser lens 104. Although the center wavelength λ₀ of the exposure light will not change, the E95 of the exposure light will be widened. The intensity of the exposure light in the center wavelength λ₀ is also reduced. Therefore, the present invention utilizes a bandwidth-filtering module 106 disposed between the condenser lens 104 and the mask 116 to split the exposure light into various exposure light beams respectively having different wavelengths and narrower bandwidth of spectrum. The exposure light beam having the center wavelength λ₀ can be gathered to be the exposure light irradiating the mask 116 so as to effectively reduce the bandwidth of spectrum of the exposure light.

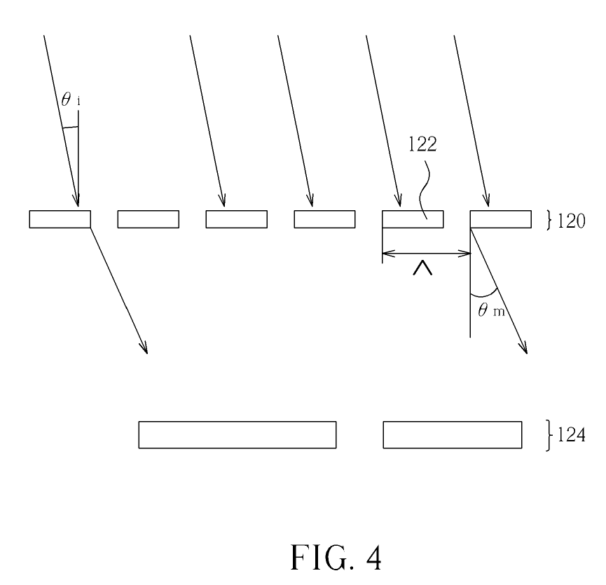

The bandwidth-filtering module of this preferred embodiment takes a grating as an example to describe an effect of filtering, but the present invention is not limited to the grating. The bandwidth-filtering module can be other devices having functions of filtering and splitting light. Referring to FIG. 4 and also referring to FIG. 3, FIG. 4 is a schematic diagram illustrating a grating. As shown in FIG. 4, the grating 120 includes a plurality of stripes 122. After the exposure light exiting from the condenser lens 104, the exposure light irradiates the grating 120 with an incident angle θᵢ. After passing through the slits between the stripes 122, the exposure light with a same wavelength will have an interference effect and the exposure light interfering with each other will exit in an emergence angle θₘ. The relationship of the incident angle and the emergence angle can be a following equation:

mλ=Λ(sin(θᵢ)+sin(θₘ)), where

λ is a wavelength of the light;

Λ is a length of combination of a stripe 122 and a slit in the grating 120;

m is an integer.

The incident exposure light includes various wavelengths, and positions of interference fringes generated by the different wavelengths of the exposure light passing through the grating 120 are different. For this reason, a position of a gathering hole 124 can be adjusted to the position of the exposure light desired to be gathered having constructive interference. Besides, the grating 120 also can be rotated to make the exposure light to be emitted to the position of the gathering hole 124. Therefore, the exposure light having narrower bandwidth of spectrum can be gathered, so that the E95 can be reduced by the bandwidth-filtering module 106 in the condition of the center wavelength λ₀ of the exposure light being unchanged.

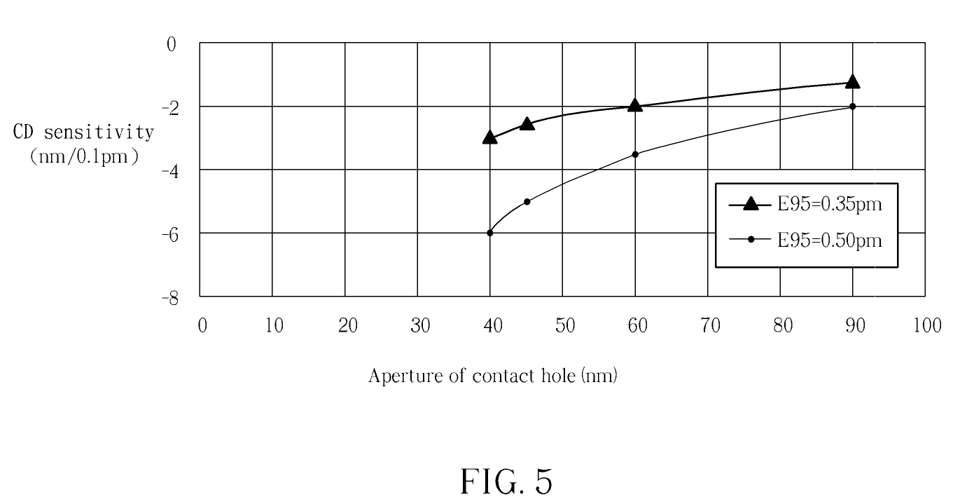

In addition, in order to clearly describe the smaller bandwidth of spectrum of the exposure light having smaller CD, refer to FIG. 5, and also refer to FIG. 3. FIG. 5 is a schematic diagram illustrating a correlation between an aperture size of a contact hole and CD sensitivity on the substrate in the condition of the exposure light having different bandwidths of spectrum.

As shown in FIG. 5, a contact hole, which has an aperture of 0.09 μm, is desired to be fabricated. In the condition of the E95 of the exposure light being 0.35 μm, when the E95 of the exposure light increases by 0.1 μm, the CD sensitivity can be reduced by substantially 1.5 nm. In the condition of the E95 of the exposure light being 0.5 μm, when the E95 of the exposure light increases by 0.1 μm, the CD sensitivity can be reduced by substantially 2 nm. Therefore, in the condition of fabricating the contact hole with 0.09 μm aperture, the E95s of the exposure light with 0.35 μm and 0.5 μm substantially have no large difference in the CD sensitivity. But a contact hole, which has aperture of 0.04 μm, is desired to be fabricated. In the condition of the E95 of the exposure light being 0.35 pm, when the E95 of the exposure light increases by 0.1 pm, the CD sensitivity can be reduced by substantially 3 nm. In the condition of the E95 of the exposure light being 0.5 pm, when the E95 of the exposure light increases by 0.1 μm, the CD sensitivity can be reduced by substantially 6 nm.

Therefore, in the condition of fabricating the contact hole with smaller aperture, when the bandwidth of spectrum is wider, the CD sensitivity will be reduced faster with the increasing of the bandwidth of spectrum. When the bandwidth of spectrum of the exposure light is reduced by the bandwidth-filtering module, the reduction of the CD sensitivity can be reduced in fabricating the smaller contact hole. The CD uniformity can be effectively raised by reducing the bandwidth of spectrum of the exposure light through the bandwidth-filtering module. The CD also can be effectively reduced so as to raise the resolution of the semiconductor element.

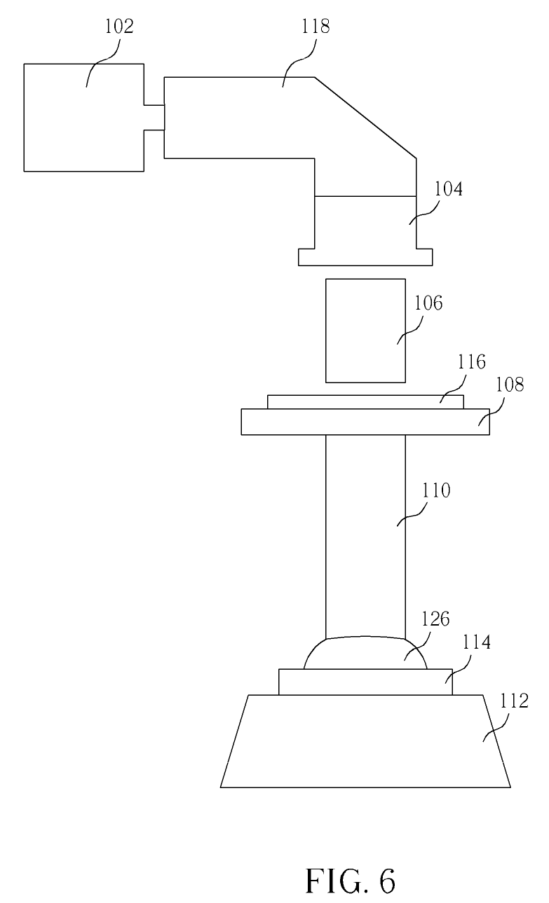

Referring to FIG. 6, FIG. 6 is a schematic diagram illustrating an example of the exposure system according to the present invention. As shown in FIG. 6, the exposure system 110 in this example further includes an immersion medium 126 disposed between the projection lens 110 and the substrate 114 and the refractive index of the immersion medium 126 is larger than the refractive index of air. The immersion medium 126 replaces the air between the projection lens 110 and the substrate 114 and the exposure light will pass through the immersion medium 126. The wavelength of the exposure light will be reduced so as to raise the resolution.

An equation of the exposure light passing through different media is λ′=λ/n, where

λ′ is a wavelength of the exposure light passing through the immersion medium 126;

λ is a wavelength of the exposure light in the air;

n is a refractive index of the immersion medium 126.

Taking the wavelength of the light source being 193 nm as an example, water is added between the projection lens 110 and the substrate 114 to be the immersion medium 126, and the wavelength of the light can be reduced to be 132 nm. It should be noted that the immersion medium 126 has higher refractive index so as to make the exposure light have dispersion effect. The dispersion effect can be reduced by adding the bandwidth-filtering module 106 before the mask 116.

In summary, the present invention utilizes a bandwidth-filtering module with functions of filtering or splitting light to be disposed between the mask and the condenser lens, so that the dispersion effect of the exposure light can be effectively improved. The bandwidth of spectrum of the exposure light can be reduced so as to raise the CD uniformity.

Those skilled in the art will readily observe that numerous modifications and alterations of the device and method may be made while retaining the teachings of the invention.

What is claimed is:

1. An exposure system for projecting a pattern on a mask to a substrate, the exposure system comprising:
a light source generating an exposure light;
a lens system disposed on light path of the exposure light and between the light source and the mask; and
a bandwidth-filtering module disposed on the light path of the exposure light and between the lens system and the mask,
wherein the bandwidth-filtering module narrows a bandwidth of spectrum of the exposure light so as to improve critical dimension uniformity.

2. The exposure system of claim 1, wherein the bandwidth-filtering module is a grating module.

3. The exposure system of claim 1, wherein the bandwidth-filtering module is a Fabry-Perot interferometer.

4. The exposure system of claim 1, wherein the bandwidth-filtering module is a distributed feedback filter.

5. The exposure system of claim 1, wherein the bandwidth-filtering module is a distributed Bragg reflector.

6. The exposure system of claim 1 further comprising a projection lens disposed between the mask and the substrate.

7. The exposure system of claim 6 further comprising an immersion medium disposed between the projection lens and the substrate, wherein the immersion medium contacts the projection lens and the substrate.

8. The exposure system of claim 7, wherein the immersion medium has a refractive index which is larger than refractive index of air.

9. The exposure system of claim 1, wherein the lens system comprises a condenser lens.

10. In an exposure system for projecting a pattern on a mask to a substrate, the exposure system having a light source generating an exposure light and a lens system disposed on light path of the light source and between the light source and the mask, wherein the improvements comprise:
a bandwidth-filtering module disposed on the light path of the exposure light and between the lens system and the mask so as to narrow a bandwidth of spectrum of the exposure light such that critical dimension uniformity is improved.

11. The exposure system of claim 10 further comprising a projection lens disposed between the mask and the substrate.

12. The exposure system of claim 11 further comprising an immersion medium disposed between the projection lens and the substrate, wherein the immersion medium contacts the projection lens and the substrate.

13. The exposure system of claim 12, wherein the immersion medium has a refractive index which is larger than refractive index of air.

14. The exposure system of claim 10, wherein the bandwidth-filtering module is a grating module.

15. The exposure system of claim 10, wherein the bandwidth-filtering module is a Fabry-Perot interferometer.

16. The exposure system of claim 10, wherein the bandwidth-filtering module is a distributed feedback filter.

17. The exposure system of claim 10, wherein the bandwidth-filtering module is a distributed Bragg reflector.

18. The exposure system of claim 10, wherein the lens system comprises a condenser lens.
